(19) United States
(12) Patent Application Publication
(10) Pub. No.: US 2004/0104381 A1
(43) Pub. Date: Jun. 3, 2004

(54) Easy lift hydraulic jack conversion kit

(76) Inventor: Junior Loyd Sharp, Fair Grove, MO (US)

Correspondence Address: Circle S Trailers, Inc., 7435 E. State Hwy E, Fair Grove, MO, 65648, US

(21) Appl. No.: 10/718,888

(22) Filed: Nov. 21, 2003

Related U.S. Application Data
(60) Provisional application No. 60/428,656, filed on Nov. 25, 2002.

(51) Int. Cl. B60S 9/02

(52) U.S. Cl. 254/423

(57) ABSTRACT

A hydraulic conversion kit designed to convert a manual jack to hydraulic, with the use of a 12V hydraulic pump, special mounting brackets, and a hydraulic motor. This changes the manual jack to the ease of push button operation.

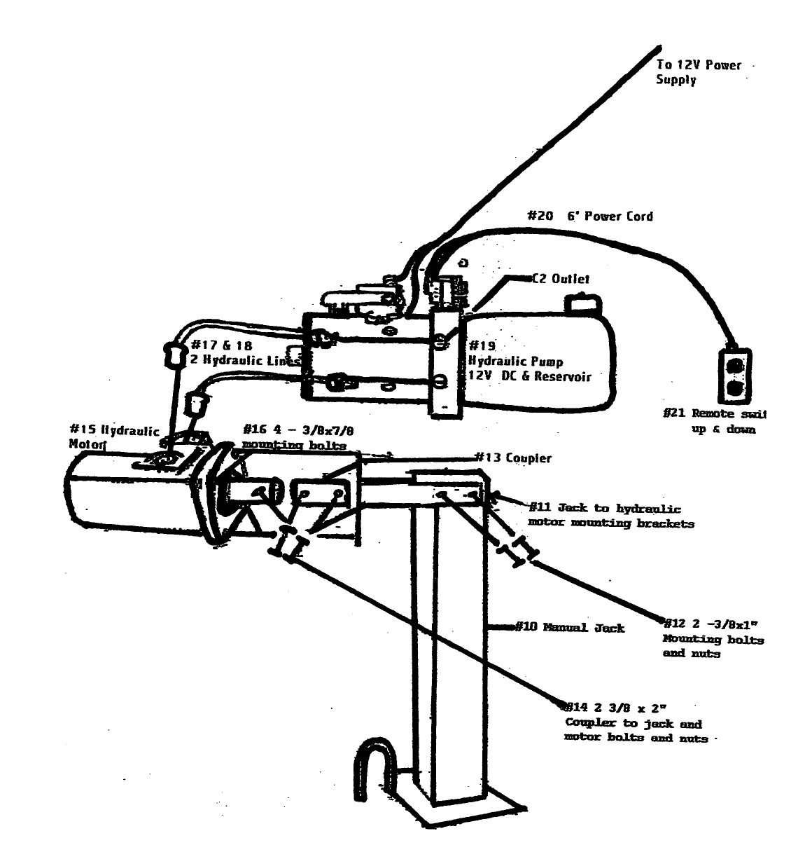

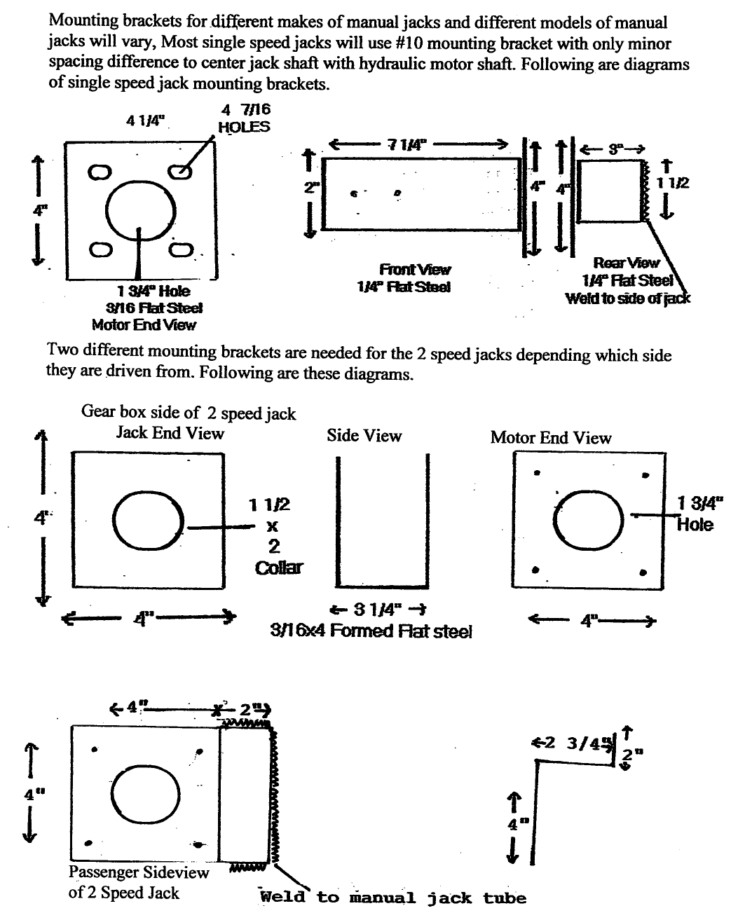

### BACKGROUND OF THE INVENTION

The “Easy Lift” Hydraulic Jack Conversion Kit is designed to make the job of hooding and unhooking of a gooseneck, 5th wheel and king pin drawn trailers much easier by applying hydraulic power to the jack instead of manual labor.

### DETAILED DESCRIPTION OF THE INVENTION

### “Easy Lift” Hydraulic Jack Conversion Kit

### Mounting Instruction

Raise jack until leg is fully retracted, then crank out ¾″ and paint ¾″ yellow stripe on jack tube, then crank out fully extended and paint another yellow stripe at top of exposed inner jack tube, let dry. Apply “Caution—Do not operate in yellow” sign, with arrows pointed down on stationary tube of jack.

Remove jack handle from jack, determine which side of jack you want motor on, then cut 1′ shaft off leaving 1″ exposed, center punch and drill ⅜″ hole ½″ from end, take care to get hole straight through shaft.

Take #15 hydraulic motor and apply to #11 motor mounting bracket and fasten with #16 4⅜×1″ bolts and lock washers, hydraulic hose connections should point upward, take #13 coupler and #14 2⅜″×2″ bolts and nylock nuts and couple motor to jack shaft loosely. Raise and lower to find center and align jack shaft and motor shaft. Mark 2 holes in front of jack. Remove 1 bolt from coupling and lay motor and bracket aside, remove top from jack and drill 2⅜″ holes in upper front of jack where marked.

Place motor and bracket both onto jack shaft and install 2⅜″×1″ bolts with flat washers, lock washers and nuts inside of jack housing and secure all bolts. Note: 2 coupler bolts should be only snug, do not tighten. Now rear brace on mounting bracket can be welded to side of jack housing.

#19-12V DC hydraulic pump usually can be mounted just above jack on channel that holds manual jack by drilling and tapping 2⅜″ holes in channel on 5″ centers. If jack is mounted on 2″ angle you will need preferably 2 3/16″×1½″ flat strap welded on 5″ centers and drilled on 5″ centers, these will have access to rear so nuts and bolts can be used (⅜″×1″, supplied).

Then connect 2 #17 and #18 hydraulic hoses and fittings supplied between hydraulic pump and motor. Teflon tape should be used on motor end, mount #21 remote up down switch where desired. Connect cylinoid on 12V DC hydraulic pump motor with 4 gauge battery cable or larger, depending on length of cable (furnished by customer).

Fill 12V DC hydraulic pump reservoir with approximately 2 quarts Dextron 111 hydraulic transmission fluid, supplied by customer. Take extreme care to keep fluid clean.

Run 12V DC pump at short intervals until all air has been purged from lines. Now you are set for the ease of push button hydraulic jack operation.

Please note in line fuse at cylinoid, this is provided for you if you feel the chance for tampering with jack is present, simply remove the fuse.

### DESCRIPTION

#10 Manual jack or landing gear supplied by trailer manufacturer.

#11 Jack to hydraulic motor mounting bracket manufactured and supplied by us.

#12 2⅜″×1″ mounting bracket bolts, lock washers and nuts supplied by us.

#13 Coupler manufactured by us to connect Hydraulic motor to jack

#14 2⅜″×2″ coupling bolts and nylock nuts to secure coupling.

#15 Hydraulic motor purchased from another manufacturer to turn jack.

#16 4⅜″×1″ motor mounting bolts.

#17&18 2 Hydraulic lines to connect hydraulic pump to hydraulic motor.

#19 12V DC hydraulic pump manufactured by another company to supply fluid to hydraulic motor that turns manual jack on demand.

#20 Power cord supplied by customer.

#21 Remote switch for pump to power up or down.

#22 Optional plastic pump cover to conceal hydraulic pump and part of hoses.

#23 Optional hydraulic motor cover to conceal hydraulic motor.

#10 Mounting bracket must be drilled to match holes in hydraulic motor with metal straps welded to it in such location as to bolt to front of jack housing and center drive shaft of hydraulic motor with center of shaft in existing manual jack. These 2 shafts will be connected with #13 coupler using #14-2⅜×2 machine bolts and nylock nuts. Mounting bracket will then be bolted to front of jack using #12-2⅜×1 mounting bolts and washers with rear support being welded to side of jack housing.

#19 12V DC hydraulic pump can usually be mounted just above jack on channel or angles that hold manual jack by drilling and tapping 2 holes in channel and mounting 12V DC hydraulic pump to them or by welding flat bar between angle flanges and drilling and bolting hydraulic pump with 2⅜×1 bolts, then connect #17 and #18-2 hydraulic hoses between hydraulic pump and hydraulic motor, mount #21 remote up/down switch where desired. Connect cylinoid on 12V DC hydraulic pump motor with 4 gauge battery cable or larger to battery furnished by customer. Fill 12V DC hydraulic pump with approximately 2 quarts Dextron 111 hydraulic transmission fluid, supplied by customer.

Run 12V DC pump at short intervals until all air has been purged from lines. Now you are set for the ease of push button hydraulic jack operation.

1. “What I claim as my invention is that knowledge, practicability and parts to apply hydraulic power to manual operated jacks or jacks sometimes referred to as landing gears.”

2. “What I claim as my invention is to take the manual labor out of raising and lowering the jack or jacks required while hooking and unhooking pick-ups, tractors, etc. to and from trailers of the Gooseneck, King Pin or flatbed types.
